(19) United States
(12) Patent Application Publication
(10) Pub. No.: US 2007/0291290 A1
(43) Pub. Date: Dec. 20, 2007

(54) System and method for file-based configuration of a document output device

(75) Inventors: Jianxin Wang, Trabuco Canyon, CA (US); Hongfeng Wei, Anaheim, CA (US); William Su, Riverside, CA (US)

Correspondence Address: TUCKER ELLIS & WEST LLP, 1150 HUNTINGTON BUILDING, 925 EUCLID AVENUE, CLEVELAND, OH, 44115-1414, US

(73) Assignee: Kabushiki Kaisha Toshiba and Toshiba Tec Kabushiki Kaisha

(21) Appl. No.: 11/453,705

(22) Filed: Jun. 15, 2006

(51) Int. Cl. G06F 15/00

(52) U.S. Cl. 358/1.9

(57) ABSTRACT

A system and method for file-based configuration of a document output device is provided. Following the receipt of electronic document data and instruction data from an associated workstation, DEVMODE data is retrieved from an XML data file. The instruction data is then compared with the DEVMODE data to determine whether the DEVMODE data requires changes so that the document output device incorporates the instruction data into the output of the electronic document. When the DEVMODE data requires updating, data stored in the data file is used to generate a new DEVMODE structure associated with the document output device. This new data is then used to output the electronic document incorporating the instructions contained within the instruction data.

### BACKGROUND OF THE INVENTION

The subject application is directed to a system and method for file-based configuration of a document output or rendering device. More particularly, the subject application is directed to a system and method for configuring a document rendering device using a file inclusive of hardware specific information during a document rendering operation.

A user of a document rendering device will typically transmit an electronic document for document rendering operations to such device via an application program. If the document rendering device to which the document rendering operation is to be submitted has its output characteristics updated or changed, such output characteristics must be updated or modified relative to the transmitted the electronic document. In addition, if a new document rendering device has been put into service, the application must be updated to reflect the characteristics of such new or modified output device. Currently, the output characteristics for document rendering devices used by an application are typically hard coded in the application program itself, or otherwise supplied by parameters set in the device on which such application program is being run. In order to update or modify the output characteristics, such as device settings, for a document rendering device used by an application, the application program or associated operating environment must be modified or reprogrammed in order that electronic documents be processed correctly by the document rendering device. The process of modifying or reprogramming an application or its operating environment is often quite time consuming, not easily modifiable and prone to error due to factors such as a mismatch between an electronic document processing request and output hardware to which it is ultimately directed. There is a need for a method and system for modifying or updating device settings of a document rendering device to which an application transmits electronic documents for processing.

The subject application overcomes the above-mentioned problems and provides a system and method for configuring a document rendering device using a file inclusive of hardware specific information during a document rendering operation.

### SUMMARY OF THE INVENTION

In accordance with the subject application, there is provided a system and method for file-based configuration of a document rendering device.

Further, in accordance with the subject application, there is provided a system and method for configuring a document rendering device.

Still further, in accordance with the subject application, there is provided a system and method for storing output characteristics of a document rendering device in a data file, wherein such data file may be retrieved during a rendering operation in order to update or modify the output characteristics of the associated device.

Still further, in accordance with the subject application, there is provided a system and method for storing output characteristics of each document rendering device used for document rendering operations in an associated data file, wherein such files may be updated or changed in accordance with additions or changes to the document rendering devices.

Still further, in accordance with the subject application, there is provided a file-based configuration system for a document output device. The system comprises input means adapted for receiving an electronic document and associated document output instruction data from an associated workstation. The document instruction data includes hardware data corresponding to at least one desired document output characteristic of an associated document rendering device. The system further comprises testing means adapted for testing output instruction data against secondary hardware data to determine positive or negative efficacy thereof. In response to a positive determination, the system includes means adapted for selectively commencing a document rendering operation on an associated document rendering device in accordance with the hardware data. In response to a negative determination by the testing means, the system also includes updating means adapted for selectively generating updated hardware data and means adapted for commencing a document rendering operation on the associated document rendering device in accordance with the updated hardware data.

Still further, in accordance with the subject application, there is provided a method for file-based configuration of a document output device. The method comprises the steps of receiving an electronic document and associated document output instruction data from an associated workstation, wherein the document instruction data includes hardware data corresponding to at least one desired document output characteristic of an associated document rendering device. The method then tests output instruction data against secondary hardware data to determine positive or negative efficacy thereof. In the event of a positive determination, the method selectively commences a document rendering operation on an associated document rendering device in accordance with the hardware data. In the event of a negative determination, the method proceeds to selectively generate updated hardware data and commence a document rendering operation on the associated document rendering device in accordance with the updated hardware data.

Preferably, hardware data includes DEVMODE data and the data file is an XML file. Also, preferably, the storage means is associated with a networked workstation or a controller of the associated document rendering device.

In one embodiment of the subject application, the system and method include the ability to store a data file inclusive of at least one of the hardware data and the updated hardware data and commence a document rendering operation in accordance with the data file.

In another embodiment, the system and method have the ability to calculate DEVMODE offset data in accordance with the DEVMODE data and associated registry data and map in accordance with offset data so as to generate the updated hardware data.

In yet another embodiment, the system and method also have the ability to receive document rendering parameters from an associated user.

Still other advantages, aspects and features of the subject application will become readily apparent to those skilled in the art from the following description wherein there is shown and described a preferred embodiment of the subject application, simply by way of illustration of one of the best modes best suited for to carry out the subject application. As it will be realized, the subject application is capable of other different embodiments and its several details are capable of modifications in various obvious aspects all without departing from the scope of the subject application. Accordingly, the drawing and descriptions will be regarded as illustrative in nature and not as restrictive.

### BRIEF DESCRIPTION OF THE DRAWINGS

The subject application is described with reference to certain figures, including:

FIG. 1 illustrates an overall system diagram for a file-based configuration system for a document output device according to the subject application;

FIG. 2 is a block diagram illustrating workstation hardware for use in the system for a file-based configuration system for a document output device according to the subject application;

FIG. 3 is a flowchart illustrating the method for file-based configuration of a document output device according to the subject application; and

FIG. 4 is a flowchart illustrating the method for file-based configuration of a document output device according to the subject application.

### DETAILED DESCRIPTION OF THE PREFERRED EMBODIMENT

The subject application is directed to a system and method for file-based configuration of a document rendering device. In particular, the subject application is directed to a system and method for configuring a document rendering device. More particularly, the subject application is directed to a system and method for storing output characteristics of a document rendering device in a data file, wherein such data file may be retrieved during a rendering operation in order to update or modify the output characteristics of the associated device. In addition, the subject application is directed to a system and method for storing output characteristics of each document rendering device used for document rendering operations in an associated data file, wherein such files may be updated or changed in accordance with additions or changes to the document rendering devices. Preferably, the document rendering device is a multifunctional peripheral device, capable of providing scanning, copying, facsimile, printing, document management, document storage, electronic mail, and other document processing functions to a user.

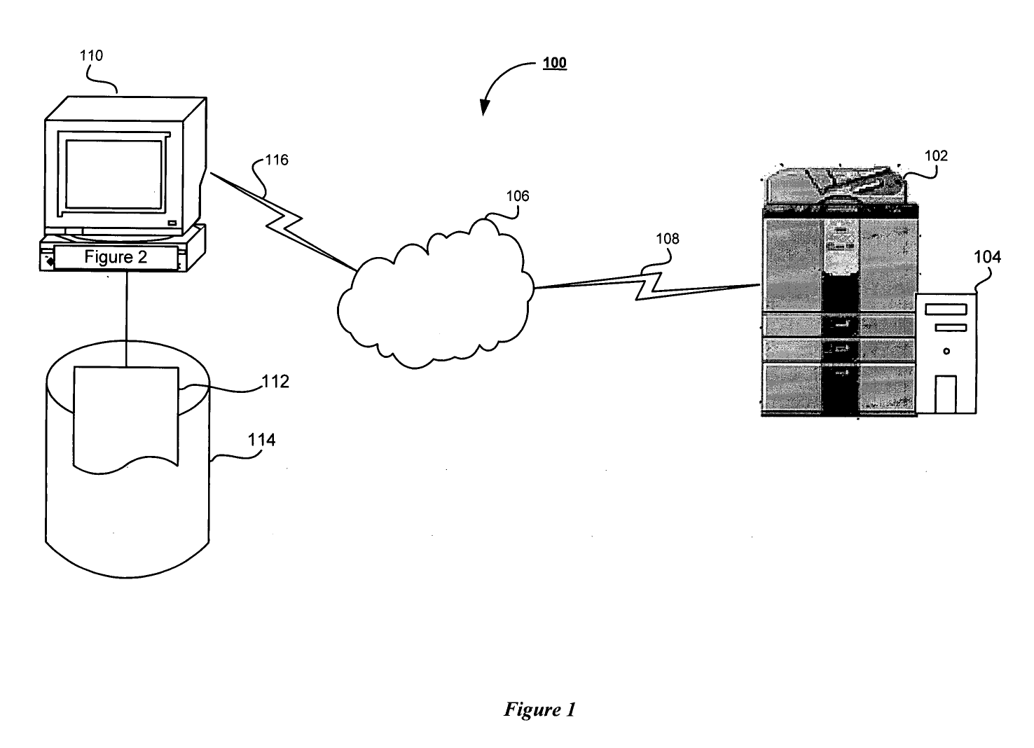

Turning now to FIG. 1, there is shown a block diagram of a system 100 in accordance with the subject application. As illustrated in FIG. 1, the system 100 includes a document rendering device 102, represented as a multifunction peripheral device. It will be appreciated by those skilled in the art that the document rendering device 102 is advantageously represented in FIG. 1 as a multifunction peripheral device, suitably adapted to provide a variety of document processing services, such as, for example and without limitation, electronic mail, scanning, copying, facsimile, document management, printing, and the like. Suitable commercially available document rendering devices include, but are not limited to, the Toshiba e-Studio Series Controller. In one embodiment, the document rendering device 102 is suitably equipped to receive a plurality of portable storage media, including without limitation, Firewire drive, USB drive, SD, MMC, XD, Compact Flash, Memory Stick, and the like. In accordance with one embodiment of the subject application, the data file 112 is suitably stored on a storage device associated with the document rendering device 102, including, for example and without limitation a hard disk driver, an internal storage device, a portable or external storage device, to the like.

The controller 104 included in the system 100 is in data communication with the document rendering device 102. It will be understood by those skilled in the art that the controller 104 is any hardware, software, or combination thereof, suitably adapted to facilitate the control of the document rendering device 102. It will further be appreciated by those skilled in the art that such control is advantageously exercised over various hardware and software components of the document rendering device 102, including, for example and without limitation, modems, network interface components, printer engines, copier components, facsimile components, optical character recognition, and the like. In accordance with one embodiment of the subject application, the data file 112 is suitably stored on a storage device associated with the controller 104, including, for example and without limitation a hard disk driver, an internal storage device, a portable or external storage device, to the like.

The document rendering device 102 is communicatively coupled to a distributed computing environment, illustrated in FIG. 1 as the computer network 106. As will be understood by those skilled in the art, the computer network 106 is any distributed computing environment known in the art enabling the exchange of data between two or more electronic devices. A suitable computer network includes, but is not limited to, the public switched telephone network, a local area network, a wide area network, the Internet, a personal area network, or the like. Communication between the computer network 106 and the document rendering device 102 is advantageously accomplished via a communications link 108. The communications link 108 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art.

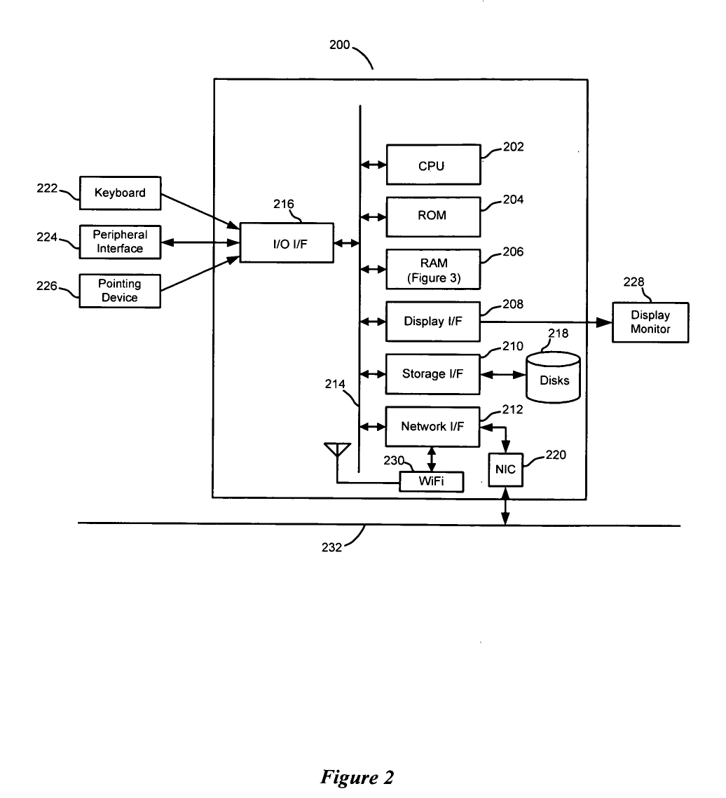

The system 100 further includes one or more client devices, illustrated in FIG. 1 as the computer workstation 110. It will be understood by those skilled in the art that the workstation 110 is representative of any personal or networked computing device known in art, including, for example and without limitation, a personal computer, a laptop computer, a personal data assistant, a workstation kiosk, a web-enabled cellular telephone, and the like. Preferably the workstation 110, representative of a client device, is embodied as hardware, software, or any suitable combination thereof, configured to perform imaging operations, programming, and the like, in accordance with the subject application. The functioning of the workstation 110, i.e., the client device, will better be understood in conjunction with the block diagram illustrated in FIG. 2, explained in greater detail below. The workstation 110 is also communicatively coupled to the computer network 106 via a suitable communications link 116. As will be understood by those skilled in the art, a suitable communications link 116 employed in accordance with the subject application includes, WiMax, 802.11a, 802.11b, 802.11g, 802.11(x), Bluetooth, the public switched telephone network, a proprietary communications network, infrared, optical, or any other suitable wired or wireless data transmission communications known in the art. In the preferred embodiment, the client device 110 is suitably adapted to generate an electronic document using any document or image generating application known in the art.

As shown in FIG. 1, the workstation 110 has access to a data file 112. In accordance with the preferred embodiment of the subject application, the data file 112 is an XML file containing data representative of hardware and software, e.g., device settings, associated with the document rendering device 102. More preferably, the data file 112 includes DEVMODE data for each document rendering device on the network. As will be appreciated by those skilled in the art, the data file 112 suitably includes the name of each printer on the network with which the workstation 110 has interacted or is capable of interacting, and offsets and mappings for all printing preferences that an application, resident on the client device 110, intends to change for each printer that is available for use by the application. In accordance with one embodiment of the subject application, the data file 112 is suitably stored on storage device 114 associated with the workstation 110, including, for example and without limitation a hard disk driver, an internal storage device, a portable or external storage device, to the like.

It will be appreciated by those skilled in the art that one aspect of the subject application enables the standalone operation of the document rendering device 102 using the data file 112 without requiring the workstation 110. Thus, when a user approaches the document rendering device 102 with an electronic document on a portable storage medium, as identified above, the controller 104 advantageously provides the modification and generation of the data file 112 in accordance with the methods discussed below.

Turning now to FIG. 2, illustrated is a hardware diagram of a suitable workstation 200, shown in FIG. 1 as the computer workstation 110, for use in connection with the subject system 100. A suitable workstation includes a processor unit 202 which is advantageously placed in data communication with read only memory 204, suitably non-volatile read only memory, volatile read only memory or a combination thereof, random access memory 206, display interface 208, storage interface 210, and network interface 212. In a preferred embodiment, interface to the foregoing modules is suitably accomplished via a bus 214.

Read only memory 204 suitably includes firmware, such as static data or fixed instructions, such as BIOS, system functions, configuration data, and other routines used for operation of the workstation 200 via CPU 202.

Random access memory 206 provides a storage area for data and instructions associated with applications and data handling accomplished by processor 202.

Display interface 208 receives data or instructions from other components on bus 214, which data is specific to generating a display to facilitate a user interface. Display interface 208 suitably provides output to a display terminal 226, suitably a video display device such as a monitor, LCD, plasma, or any other suitable visual output device as will be appreciated by one of ordinary skill in the art.

Storage interface 210 suitably provides a mechanism for non-volatile, bulk or long term storage of data or instructions in the workstation 200. Storage interface 210 suitably uses a storage mechanism, such as storage 218, suitably comprised of a disk, tape, CD, DVD, or other relatively higher capacity addressable or serial storage medium.

Network interface 212 suitably communicates to at least one other network interface, shown as network interface 220, such as a network interface card. It will be appreciated that by one or ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by on of ordinary skill in the art.

An input/output interface 216 in data communication with bus 214 is suitably connected with an input device 222, such as a keyboard or the like. Input/output interface 216 also suitably provides data output to a peripheral interface 224, such as a USB, universal serial bus output, SCSI, Firewire (IEEE 1394) output, or any other interface as may be appropriate for a selected application. Finally, input/output interface 216 is suitably in data communication with a pointing device interface 228 for connection with devices, such as a mouse, light pen, touch screen, or the like.

In operation, the workstation 110 calculates the DEVMODE offset values for each printing preference of a given printer. This calculation is accomplished by comparing the binary data stored in the workstation 110 registry before and after a printing preference is changed from one setting to another. Once this offset has been calculated, the mapping between the numeric offset value and the preference setting is determined. All offsets and mappings are then stored in the data file 112, for each printer currently used or which is capable of becoming available for future use. Preferably, all offsets and mappings are stored in the data file 112 according to each document rendering device, such that each document rendering device 102 on the network 106 has its own set of offsets and mappings. The data file 112 further includes an entry designating the current document rendering device 102 used by a particular application resident on the workstation 110.

Prior to transmission of an electronic document to the document rendering device 102, the workstation 110, or the application running thereon, prompts an associated user for new instruction data. The skilled artisan will appreciate that suitable instruction data corresponds to updated processing preferences to be implemented during the processing of the electronic document by the document rendering device 102. The application then retrieves the current document rendering device 102 name and information from the data file 112, along with the offset and mapping data. The application then modifies the DEVMODE data for the specified document rendering device 102 in the client device 110 registry using the offsets, mappings, and user selected preferences. Following update of the registry, the electronic document, with updated processing preferences, is transmitted to the selected document rendering device 102 for processing.

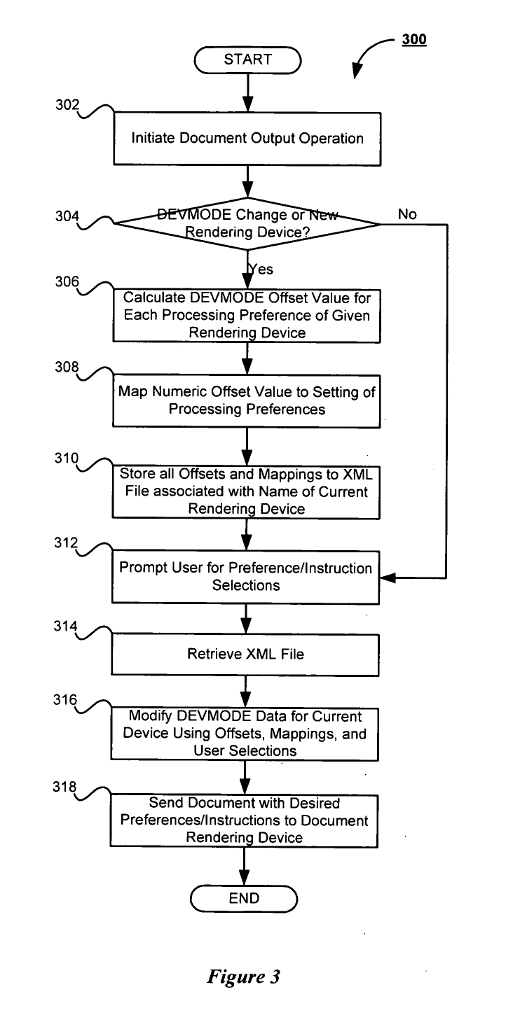

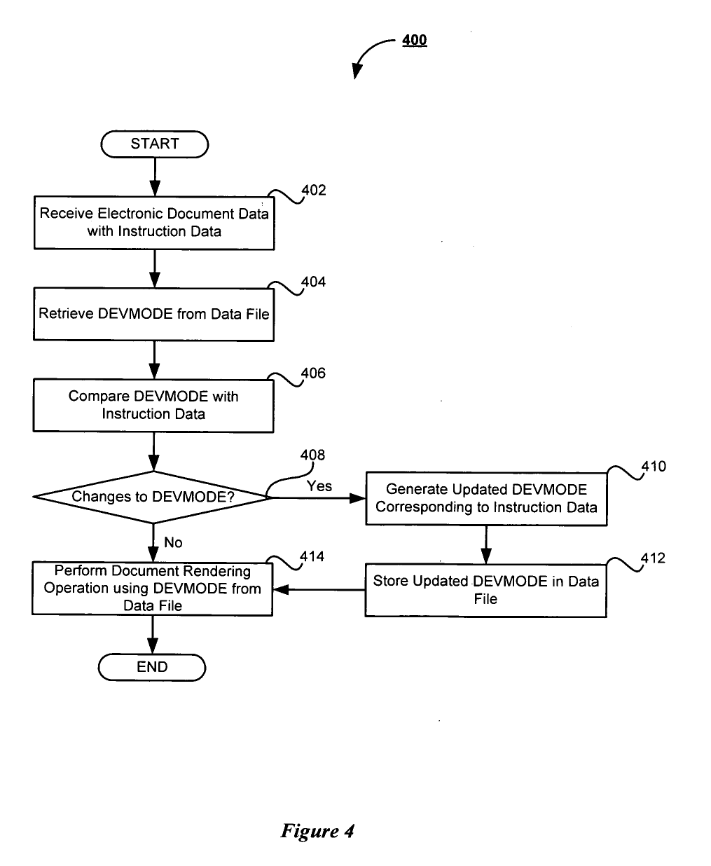

The skilled artisan will better appreciate the system 100 and components of the subject application depicted in FIGS. 1 and 2 when interpreted in conjunction with the flowcharts illustrated in FIG. 3 and FIG. 4. Referring now to FIG. 3, there is shown an XML data file 112 generation by the workstation 110 in accordance with the subject application. It will be appreciated by those skilled in the art that while the method embodied in FIG. 3 is shown with respect to DEVMODE, the methodology is not so limited and is capable of application to other hardware data. Beginning at step 302, an application resident on the workstation 110 initiates a document rendering operation via any suitable means known in the art. A determination is then made at step 304, whether the DEVMODE associated with the selected document rendering device 102 has changed, or if a new document rendering device has been selected. When it has been determined at step 304 that the selected document rendering device 102 is not a new device, nor has the DEVMODE changed, flow proceeds to step 312, whereupon the associated user is prompted to input preferences/instructions. At step 314, the XML data file 112 is retrieved by the client device and the DEVMODE contained therein is modified at step 316 using the offsets, mappings, and user input preferences/instructions. It will be appreciated by those skilled in the art that the modified DEVMODE is then stored in the XML data file 112 and the registry associated with the client device 110 is suitably updated to reflect the new DEVMODE structure. The document with desired preferences is then sent to the document rendering device 102 at step 318.

Returning to step 304, when it has been determined that the selected document rendering device is new, or when the DEVMODE has been changed, flow proceeds to step 306, whereupon the workstation 110 calculates the DEVMODE offset for each document processing preference of a given printer by comparing the binary data stored in the workstation 110 registry before and after each document processing preference is changed from one setting to another. Once this offset is calculated, flow proceeds to step 308, whereupon the mapping between the numeric offset value and the setting of each document processing preference is determined. The offsets and mappings for all the document processing preferences that an application resident on the workstation 110 intends to change are stored in a data file 112 at step 310. The skilled artisan will appreciate the data file 112 is thereby capable of being updated when the current document rendering device 102 experiences changes to the DEVMODE structure associated therewith.

When the user desires to request document processing, via the application, the user is prompted to input selected processing instructions at step 312. It will be understood by those skilled in the art that the processing instructions are capable of including document rendering preferences, differing from or the same as, those previously selected for the selected document rendering device 102. The workstation 110, via the application, then retrieves the data contained in the data file 112 at step 314. Preferably, the data retrieved from the XML data file 112 at step 310 includes the name of the current document rendering device 102 and the offsets and mappings associated therewith. The DEVMODE data for the current document rendering device 102 is then modified at step 316 using the offsets, mappings, and new selected document processing instructions. In one embodiment, the skilled artisan will appreciate that the modified DEVMODE data is then stored in the XML data file 112 for future use by the client device. The electronic document is then sent to the document rendering device 102 at step 318, along with the desired document processing instructions mapped above.

Turning now to FIG. 3, there is shown a flowchart 400 illustrating the operation of the document rendering device 102 in accordance with one aspect of the subject application. As shown in FIG. 4, the document rendering device 102 receives, at step 402, electronic document data and associated instruction data. As will be appreciated by those skilled in the art, the document rendering device 102 is capable of receiving the electronic document data and instruction data via the computer network 106, directly from an associated user and removable storage medium, or the like. The hardware data, or DEVMODE data in the preferred embodiment, is then retrieved from the XML data file 112 at step 404. The skilled artisan will appreciate that while DEVMODE is employed herein, the subject application is advantageously capable of being applied to other hardware data, as will be understood by those skilled in the art. At step 406, the received instruction data is compared to the DEVMODE data to determine whether any changes to the DEVMODE are warranted by the instruction data.

It will be understood by those skilled in the art that the instruction data suitably includes, for example and without limitation, data representative of document processing instructions as set by the associated user. When it is determined at step 408 that changes to the DEVMODE data are required by the instruction data, flow proceeds to step 410, whereupon the DEVMODE data is modified corresponding to the received instruction data. The modification of the DEVMODE data is accomplished using the offsets and mappings retrieved from the data file 112 and the instruction data. The updated DEVMODE data is then stored in the data file 112 at step 412, whereupon the requested document rendering operation is performed on the electronic document in accordance with the updated DEVMODE stored in the data file 112. When the instruction data does not require changes to the DEVMODE, flow proceeds from step 408 to step 414, whereupon the requested document rendering operation is performed on the electronic document using the DEVMODE data retrieved from the data file 112.

The subject application extends to computer programs in the form of source code, object code, code intermediate sources and object code (such as in a partially compiled form), or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A file-based configuration system for a document output device comprising:
input means adapted for receiving an electronic document and associated document output instruction data from an associated workstation, which document instruction data has associated therewith hardware data corresponding to at least one desired document output characteristic of an associated document rendering device;
testing means adapted for testing output instruction data against secondary hardware data to determine positive or negative efficacy thereof;
means adapted for selectively commencing, upon a determination of positive efficacy by the testing means, a document rendering operation on an associated document rendering device in accordance with the hardware data;
updating means adapted for selectively generating updated hardware data upon a determination of negative efficacy by the testing means; and
means adapted for commencing a document rendering operation on the associated document rendering device in accordance with the updated hardware data.

2. The file-based configuration system for a document output device of claim 1 further comprising:
storage means adapted for storing a data file inclusive of at least one of the hardware data and the updated hardware data; and
means adapted for commencing a document rendering operation in accordance with the data file.

3. The file-based configuration system for a document output device of claim 2 wherein the hardware data includes DEVMODE data.

4. The file-based configuration system for a document output device of claim 2 wherein the data file is comprised of an XML file.

5. The file-based configuration system for a document output device of 2 wherein the storage means is associated with at least one of a networked workstation.

6. The file-based configuration system for a document output device of claim 2 wherein the storage means is associated with a controller of the associated document rendering device.

7. The file-based configuration system for a document output device of claim 1 wherein the updating means includes:
means adapted for calculating DEVMODE offset data in accordance with the DEVMODE data and associated registry data; and
mapping means adapted for mapping in accordance with offset data so as to generate the updated hardware data.

8. The file-based configuration system for a document output device of claim 1 further comprising means adapted for receiving document rendering parameters from an associated user.

9. A file-based configuration method for a document output device comprising the steps of:
receiving an electronic document and associated document output instruction data from an associated workstation, which document instruction data has associated therewith hardware data corresponding to at least one desired document output characteristic of an associated document rendering device;
testing output instruction data against secondary hardware data to determine positive or negative efficacy thereof;
selectively commencing, upon a determination of positive efficacy, a document rendering operation on an associated document rendering device in accordance with the hardware data;
selectively generating updated hardware data upon a determination of negative efficacy; and
commencing a document rendering operation on the associated document rendering device in accordance with the updated hardware data.

10. The file-based configuration method for a document output device of claim 9 further comprising the steps of:
storing a data file inclusive of at least one of the hardware data and the updated hardware data; and
commencing a document rendering operation in accordance with the data file.

11. The file-based configuration method for a document output device of claim 10 wherein the hardware data includes DEVMODE data.

12. The file-based configuration method for a document output device of claim 10 wherein the data file is comprised of an XML file.

13. The file-based configuration method for a document output device of 10 wherein the data file is stored in a storage means associated with a networked workstation.

14. The file-based configuration method for a document output device of claim 10 wherein the data file is stored in a storage means associated with a controller of the associated document rendering device.

15. The file-based configuration method for a document output device of claim 9 wherein the step of updating further comprises the steps of:
calculating DEVMODE offset data in accordance with the DEVMODE data and associated registry data; and
mapping in accordance with offset data so as to generate the updated hardware data.

16. The file-based configuration method for a document output device of claim 9 further comprising means adapted for receiving document rendering parameters from an associated user.

17. A computer-implemented method for file-based configuration of a document output device comprising the steps of:
receiving an electronic document and associated document output instruction data from an associated workstation, which document instruction data has associated therewith hardware data corresponding to at least one desired document output characteristic of an associated document rendering device;
testing output instruction data against secondary hardware data to determine positive or negative efficacy thereof;
selectively commencing, upon a determination of positive efficacy, a document rendering operation on an associated document rendering device in accordance with the hardware data;
selectively generating updated hardware data upon a determination of negative efficacy; and
commencing a document rendering operation on the associated document rendering device in accordance with the updated hardware data.

18. The computer-implemented method for file-based configuration of a document output device of claim 17 further comprising the steps of:
storing a data file inclusive of at least one of the hardware data and the updated hardware data; and
commencing a document rendering operation in accordance with the data file.

19. The computer-implemented method for file-based configuration of a document output device of claim 18 wherein the hardware data includes DEVMODE data and the data file is comprised of an XML file; and
wherein the data file is stored in a storage means associated with at least one of the group consisting of a networked workstation and a controller of the associated document rendering device.

20. The computer-implemented method for file-based configuration of a document output device of claim 17 wherein the step of updating further comprises the steps of:
calculating DEVMODE offset data in accordance with the DEVMODE data and associated registry data; and
mapping in accordance with offset data so as to generate the updated hardware data.
